(19) United States
(12) Patent Application Publication
(10) Pub. No.: US 2023/0401489 A1
(43) Pub. Date: Dec. 14, 2023

(54) KERNEL LEARNING APPARATUS USING TRANSFORMED CONVEX OPTIMIZATION PROBLEM

(71) Applicant: NEC Corporation, Tokyo (JP)

(72) Inventors: Hao ZHANG, Tokyo (JP); Shinji NAKADAI, Tokyo (JP); Kenji FUKUMIZU, Tokyo (JP)

(73) Assignee: NEC Corporation, Tokyo (JP)

(21) Appl. No.: 18/239,542

(22) Filed: Aug. 29, 2023

Related U.S. Application Data
(63) Continuation of application No. 17/041,733, filed on Sep. 25, 2020.

(51) Int. Cl. G06N 20/10; G06F 17/14; G06F 18/214; G06F 18/2135; G06F 18/213

(52) U.S. Cl. CPC G06N 20/10; G06F 17/14; G06F 18/214; G06F 18/21355; G06F 18/213

(57) ABSTRACT

In a kernel learning apparatus, a data preprocessing circuitry preprocesses and represents each data example as a collection of feature representations that need to be interpreted. An explicit feature mapping circuit designs a kernel function with an explicit feature map to embed the feature representations of data into a nonlinear feature space and to produce the explicit feature map for the designed kernel function to train a predictive model. A convex problem formulating circuitry formulates a non-convex problem for training the predictive model into a convex optimization problem based on the explicit feature map. An optimal solution solving circuitry solves the convex optimization problem to obtain a globally optimal solution for training an interpretable predictive model.

### CROSS-REFERENCE TO RELATED APPLICATIONS

The present application is a continuation application of U.S. patent application Ser. No. 17/041,733 filed on Sep. 25, 2020, which is a National Stage Entry of International Application PCT/JP2018/012159 filed Mar. 26, 2018, the disclosures of which is incorporated herein in its entirety by reference.

### TECHNICAL FIELD

The present invention relates to a kernel-based machine learning approach, and in particular to an interpretable and efficient method and system of kernel learning.

### BACKGROUND ART

Machine learning approaches have been widely applied in data science for building predictive models. To train a predictive model, a set of data examples with known labels is used as the input of a learning algorithm. After training, the fitted model is utilized to predict the labels of data examples that have not been seen before.

The representation of data is one of the essential factors that affect prediction accuracy. Usually, each data example is preprocessed and represented by a feature vector in a feature space. Kernel-based methods are a family of powerful machine learning approaches in terms of prediction accuracy, owing to the capability of mapping each data example to a high-dimensional (possibly infinite) feature space. The representation of data in this feature space is able to capture nonlinearity in data, e.g., infinite-order interactions among features can be represented in cases of the Gaussian Radial basis function (RBF) kernel. Moreover, the feature map in kernel-based methods is implicitly built, and the corresponding inner product can be directly computed via a kernel function. This is known as the “kernel trick”.

Nevertheless, the implicit feature map in a standard kernel function is difficult to interpret by humans, e.g., different effects of the original features on prediction cannot be clearly explained. This makes standard kernel-based methods unattractive in application domains such as marketing and healthcare, where model interpretability is highly required.

Multiple kernel learning (MKL) is designed for the problems that involve multiple heterogeneous data sources. Additionally, MKL can also provide interpretability for the resulting model, as discussed by Non Patent Literature 1. Specifically, the kernel function is considered as a convex combination of multiple sub-kernels in MKL, where each sub-kernel is evaluated on a feature representation, e.g., a subset of the original features. By optimizing the combination coefficients, it is possible to explain the effects of different feature representations on prediction. Patent Literature 1 discloses a machine learning for object identification. Patent Literature 1 describes, as the machine learning approach, an example of MKL using a Support Vector Machine (SVM) as a known technique.

Unfortunately, standard kernel-based methods suffer from the scalability issue, due to the storage and computation costs of the dense kernel matrix (generally quadratic in the number of data examples). This is even worse when using multiple kernels, because multiple kernel matrices have to be stored and computed.

Recently, several techniques have been developed for addressing the scalability issue of kernel methods. One of them is called random Fourier features (RFF), described by Non Patent Literature 2. The key idea of RFF is to directly approximate the kernel function using explicit randomized feature maps. Since the feature maps are explicitly built, large-scale problems can be solved by exploiting efficient linear algorithms without computing kernel matrices. Patent Literature 2 discloses, as one example of hash functions, a hash function based on Shift-Invariant Kernels that projects to a hash value using RFF.

As a remedy for the scalability issue, RFF is able to reduce the complexity of standard MKL from quadratic to linear in the number of data examples. However, it is still not computationally efficient when the number of sub-kernels is large, which is the usual case in MKL.

Alternating direction method of multipliers (ADMM) is a popular algorithm for distributed convex optimization. ADMM is particularly attractive for large-scale problems, because it can break the problem at hand into sub-problems that are easier to solve in parallel if the original problem can be transformed into an ADMM form. ADMM is thoroughly surveyed by Non Patent Literature 3. Patent Literature 3 discloses a ranking function learning apparatus in which an optimization problem is solved using an optimization scheme called ADMM.

### CITATION LIST

### Patent Literature

[PTL 1]
JP 2015-001941 A
[PTL 2]
JP 2013-068884 A
[PTL 3]
JP 2013-117921 A

### Non Patent Literature

[NPL 1]
S. Sonnenburg, G. Raetsch, C. Schaefer, and B. Schoelkopf in “Large scale multiple kernel learning”, Journal of Machine Learning Research, 7(1):1531-1565, 2006.
[NPL 2]
A. Rahimi and B. Recht in “Random features for large-scale kernel machines”, Advances in Neural Information Processing Systems 20, J. C. Platt, D. Koller, Y Singer, and S. T. Roweis, Eds. Curran Associates, Inc., 2008, pp. 1177-1184.
[NPL 3]
S. Boyd, N. Parikh, E. Chu, B. Peleato, and J. Eckstein in “Distributed optimization and statistical learning via the alternating direction method of multipliers”, Foundations and Trends in Machine Learning, 3(1):1-122, 2011.

### SUMMARY OF INVENTION

### Technical Problem

The objective of this invention is to address the interpretability issue of standard kernel learning via an efficient distributed optimization approach and system.

In standard kernel learning, a kernel function is defined as the inner product of implicit feature maps. However, it is difficult to interpret different effects of features because all of them are packed into the kernel function in a nontransparent way. In multiple kernel learning (MKL), the kernel function is considered as a convex combination of sub-kernels, with each sub-kernel evaluated on a certain feature representation. To interpret the effects of different feature representations, an optimization problem is solved to obtain the optimal combination of sub-kernels. Unfortunately, this optimization process usually involves computing multiple kernel matrices, which is computationally expensive (generally quadratic in the number of data examples). Random Fourier features (RFF) is a popular technique of kernel approximation. In RFF, the feature map is explicitly built so that efficient linear algorithms can be exploited to avoid computing kernel matrices. RFF alleviates the computational issue of standard kernel-based methods when the number of data examples is large, that is, reducing the computation complexity from quadratic to linear in the number of data examples. Nevertheless, more efficient computational mechanisms are required if the effects of a large number of feature representations need to be interpreted.

### Solution of Problem

A mode of the present invention comprises several components and steps: preprocessing and representing each data example as a collection of feature representations that need to be interpreted; designing a kernel function with an explicit feature map to embed the feature representations of data into a nonlinear feature space and to produce the explicit feature map for the designed kernel function to train a predictive model; formulating a non-convex problem for training the predictive model into a convex optimization problem based on the explicit feature map; and solving the convex optimization problem to obtain a globally optimal solution for training an interpretable predictive model.

### Advantageous Effects of Invention

An exemplary effect of the present invention is that interpretable yet efficient kernel learning can be conducted for training predictive models in a distributed way.

### BRIEF DESCRIPTION OF DRAWINGS

FIG. 1 is a block diagram that illustrates a structure example of a kernel learning apparatus according to an example embodiment of the present invention, which is an overview framework of interpretable and efficient kernel learning.

FIG. 2 is a flow diagram that illustrates an operation example of the kernel learning apparatus according to an example embodiment of the present invention, which is an ADMM-based optimization process with inner update.

FIG. 3 is a flow diagram that illustrates an operation example of the kernel learning apparatus according to an example embodiment of the present invention, which is an ADMM-based optimization process with outer update.

FIG. 4 is an illustrative plot that shows a toy example of the difference between convex and non-convex optimization problems, where non-convex optimization suffers from local optima issues while convex optimization does not.

FIG. 5 shows a graph indicative of a ranking of the degree of importance for the features in the prediction task.

FIG. 6 shows a graph where the abscissa represents an amount of the “MedInc” and the ordinate represents the partial dependence of contribution for the house value.

FIG. 7 shows a graph where the abscissa represents an amount of the “Latitude” and the ordinate represents the partial dependence for the house value.

FIG. 8 shows a graph where the abscissa and the ordinate represent a set of features representing the interaction effect and the partial dependence is denoted at a change of shading in a color.

### DESCRIPTION OF EMBODIMENTS

The present invention provides an approach and system for interpretable and efficient kernel learning.

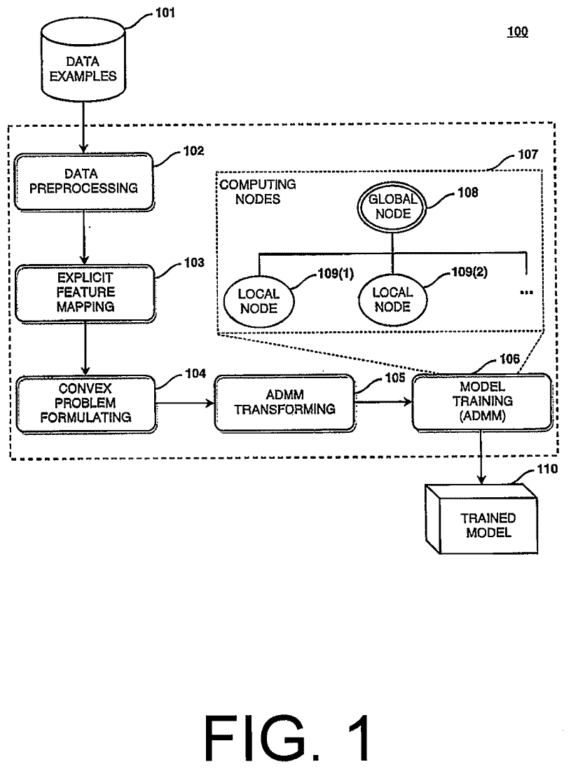

FIG. 1 is a block diagram that illustrates a structure example of a kernel learning apparatus according to an example embodiment in the present invention. The kernel learning apparatus 100 in this example embodiment includes a data preprocessing component 102, an explicit feature mapping component 103, a convex problem formulating component 104, an alternating direction method of multipliers (ADMM) transforming component 105, and a model training component 106. The model training component 106 comprises a distributed computing system, and a group of computing nodes 107 in this system perform computation for model training based on the ADMM. There are two types of computing nodes: a global node 108 and several local nodes 109(1), 109(2), . . .

The data preprocessing component 102 extracts features from data examples 101 and represent them as feature vectors. Let

{xᵢ}ᵢ₌₁^{N} [Math. 1]

be the set of feature vectors for N data examples, where the vector

xᵢ=( [symbol] ᵢ₁, . . . , [symbol] _{iD}) ∈ [symbol] ^{D} [Math. 2]

represents the i-th example with D features in total. Furthermore, the data preprocessing component 102 may also extract a collection of feature representations specified by users according to their interests. The effects of these feature representations on prediction may be interpreted in the trained model 110. Let

{xᵢ^{(k)}}ₖ₌₁^{K} [Math. 3]

be the set of K feature representations for the i-th data example, where the vector

xᵢ^{(k)} [Math. 4]

includes a subset of the original D features with the size D^{t}. Let yᵢ be the corresponding prediction target for the i-th example. If the task at hand is regression, then

[symbol]

ᵢ∈ [symbol] [Math. 5]

if the task is classification, then

[symbol]

ᵢ∈{−1,1}. [Math. 6]

For example, in the context of housing value prediction, users may have features such as income of residents, number of rooms, latitude and longitude of house. Users may be interested in the effect of intersection between latitude and longitude as well as that a single feature like income of residents. In this case, users may specify a feature representation only including latitude and longitude, and its effect on prediction may be captured in the trained model 110.
The explicit feature mapping component 103 embeds the feature representations into a nonlinear feature space produced by the kernel function designed in this example embodiment. Specifically, this kernel function is defined as:

$$\begin{matrix}[ Math . 7 ] & \\ {κ}_{β} ( x , z ) := {\sum }_{k = 1}^{K} {β}^{( k )} {\hat{κ}}_{GAU} ( {x}^{( k )} , {z}^{( k )} ) = {\sum }_{k = 1}^{K} {β}^{( k )} 〈 \hat{ϕ} ( {x}^{( k )} ) , \hat{ϕ} ( {x}^{( k )} ) 〉 , & ( 1 )\end{matrix}$$

where

\hat{K}_{GAU}(x^{(k)}, z^{(k)}) [Math. 8]

is a sub-kernel evaluated on the k-th feature representation, and

β=(β⁽¹⁾, β⁽²⁾, . . . , β^{(κ)}) ∈ [symbol] ₊^{κ} [Math. 9]

with

∥β∥₁=1 [Math. 10]

are the coefficients of sub-kernels to optimize. The sub-kernel

\hat{κ}_{GAU} [Math. 11]

is an approximation of the Gaussian kernel via random Fourier features (RFF), with the explicit feature map as

$$[ Math . 12 ] \\ \hat{ϕ} : {ℝ}^{{D}^{′}} \to {d}^{} ,$$

$$\begin{matrix}[ Math . 13 ] & \\ \hat{ϕ} ( {x}^{( k )} ) := \sqrt{\frac{2}{d}} ( cos ( {ω}_{1}^{T} {x}^{( k )} ) , sin ( {ω}_{1}^{T} {x}^{( k )} ) , … , cos ( {ω}_{d / 2}^{T} {x}^{( k )} ) , sin ( {ω}_{d / 2}^{T} {x}^{( k )} ) ) , {\{ {ω}_{i} \}}_{i = 1}^{d / 2} {∼}^{i . i . d .} ( {0}_{{D}^{′}} , {σ}^{- 2} {I}_{{D}^{′}} ) . & ( 2 )\end{matrix}$$

In standard kernel learning, the feature map is implicit and the kernel matrix has to be computed via the kernel function for the optimization process. In contrast, the designed kernel function in Equation (1) is not directly used; instead, the corresponding feature map is explicitly built so that efficient linear algorithms may be exploited in the optimization process. According to Equation (1) and Equation (2), the explicit feature map for the designed kernel function may be written as

$$[ Math . 14 ] \\ {ϕ}_{β} : {ℝ}^{D} \to {dK}^{} ,$$

$$\begin{matrix}[ Math . 15 ] & \\ {ϕ}_{β} ( x ) = ( \sqrt{{β}^{( 1 )}} \hat{ϕ} ( {x}^{( 1 )} ) , \sqrt{{β}^{( 2 )}} \hat{ϕ} ( {x}^{( 2 )} ) , … , \sqrt{{β}^{( K )}} \hat{ϕ} ( {x}^{( K )} ) ) , & ( 3 )\end{matrix}$$

$$so that \\ [ Math . 16 ] \\ 〈 {ϕ}_{β} ( x ) , {ϕ}_{β} ( z ) 〉 = {\sum }_{k = 1}^{K} 〈 \sqrt{{β}^{( k )}} \hat{ϕ} ( {x}^{( k )} ) , \sqrt{{β}^{( k )}} \hat{ϕ} ( {z}^{( k )} ) 〉 = {κ}_{β} ( x , z ) .$$

With this explicit feature map in Equation (3), efficient linear algorithms may be exploited to train a predictive model

$$\begin{matrix}[ Math . 17 ] & \\ f ( x ) = 〈 x , {ϕ}_{β} ( x ) 〉 = {\sum }_{k = 1}^{K} 〈 {w}^{( k )} , \sqrt{{β}^{( k )}} \hat{ϕ} ( {x}^{( k )} ) 〉 , & ( 4 )\end{matrix}$$

$$where \\ [ Math . 18 ] \\ {w}^{( k )} ∈ {d}^{}$$

is a sub-vector of

w∈ [symbol] ^{dκ}, [Math. 19]

The convex problem formulating component 104 casts the problem of training a predictive model in Equation (4) as a convex optimization problem, where a globally optimal solution is to be obtained.

A predictive model in Equation (4) may be trained by solving the optimization problem

$$\begin{matrix}[ Math . 20 ] & \\ {min}_{β , w} {\sum }_{i = 1}^{N} L ( {y}_{i} - {\sum }_{k = 1}^{K} 〈 {w}^{( k )} , \sqrt{{β}^{( k )}} \hat{ϕ} ( {x}_{i}^{( k )} ) 〉 ) + \frac{λ}{2} {‖ w ‖}_{2}^{2} \\ s . t . β \geq 0 , {‖ β ‖}_{1} = 1 & ( 5 )\end{matrix}$$

where

L(·) [Math. 21]

is a convex loss function. In Problem (5), the square loss is chosen as

L(·) [Math. 22]

for a regression task, but depending on the task at hand, there are also other choices such as the hinge loss for classification tasks.

[symbol]

₂-regularizer [Math. 23]

is imposed for w, and λ>0 is its parameter. β is constrained due to the definition of the designed kernel function in Equation (1). That is, the optimization problem (5) formulates a one-shot problem instead of two-phase.

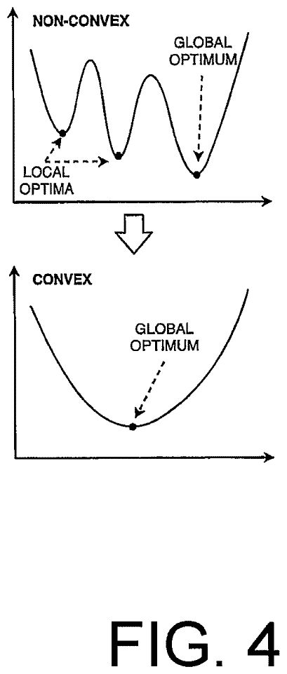

However, Problem (5) is non-convex in the current form, meaning that a globally optimal solution may be difficult to obtain. For illustration, the upper panel of FIG. 4 shows a toy non-convex function. It is desired change the form of Problem (5) into a convex one, where a global optimum is to be obtained. A toy example of convex function is shown in the lower panel of FIG. 4.

To make the problem convex, let

\tilde{w}^{(k)}:=\sqrt{β^{(k)}w^{(k)}} for k=1, . . . ,K. [Math. 24]

Then the following convex optimization problem may be solved equivalently to obtain a globally optimal solution.

$$\begin{matrix}[ Math . 25 ] & \\ {min}_{β , w} {\sum }_{i = 1}^{N} L ( {y}_{i} - {\sum }_{k = 1}^{K} 〈 {w}^{( k )} , \hat{ϕ} ( {x}_{i}^{( k )} ) 〉 ) + \frac{λ}{2} {\sum }_{k = 1}^{K} \frac{{‖ {\overline{w}}^{( k )} ‖}_{2}^{2}}{{β}^{( k )}} \\ s . t . β \geq 0 , {‖ β ‖}_{1} = 1 & ( 6 )\end{matrix}$$

$$[ Math . 26 ] \\ {\overline{w}}^{( k )} ∈ {d}^{}$$

is a sub-vector of

\tilde{w}∈ [symbol] ^{dκ}. [Math. 27]

As described above, the convex problem formulating component 104 is configured to formulate a non-convex problem for training the predictive model into the convex optimization problem based on the explicit feature map by using a variable substitution trick.

The ADMM transforming component 105 transforms the convex optimization problem in Problem (6) into an ADMM form, and then the model training component 106 distributes the computation for training a predictive model among a group of computing nodes to perform ADMM iterations.

To efficiently solve Problem (6), it is convenient to alternatively minimize the objective function

w.r.t. \tilde{w} [Math. 28]

and w.r.t. β. First, the minimization

w.r.t. \tilde{w}: [Math. 29]

is considered with a fixed feasible β, and Problem (6) is written in a compact form as

$$\begin{matrix}[ Math . 30 ] & \\ {min}_{\overline{w}} L ( {\sum }_{k = 1}^{K} {Φ}^{( k )} {\overline{w}}^{( k )} - y ) + \frac{λ}{2} {\sum }_{k = 1}^{K} \frac{{‖ {\overline{w}}^{( k )} ‖}_{2}^{2}}{{β}^{( k )}} , & ( 7 )\end{matrix}$$

where the k-th block of embedded data is

Φ^{(k)}∈ [symbol] ^{N×d} [Math. 31]

with the i-th row as

\hat{ϕ}(xᵢ^{(k)}) [Math. 32]

and the vector of prediction target is

y∈ [symbol] ^{N} [Math. 33]

with the i-th element as yᵢ.

In Problem (7),

\tilde{w} [Math. 34]

is separated into sub-vectors

\tilde{w}^{(k)} [Math. 35]

in the same way in the loss function and regularization terms. Hence, it can be expressed in an ADMM form as

$$\begin{matrix}[ Math . 36 ] & \\ {min}_{\overline{w} , v} L ( {\sum }_{k = 1}^{K} {v}^{( k )} - y ) + \frac{λ}{2} {\sum }_{k = 1}^{K} \frac{{‖ {\overline{w}}^{( k )} ‖}_{2}^{2}}{{β}^{( k )}} \\ s . t . {Φ}^{( k )} {\overline{w}}^{( k )} - {v}^{( k )} = 0 , for k = 1 , … , K & ( 8 )\end{matrix}$$

with auxiliary variables

v^{(k)}∈ [symbol] ^{N}. [Math. 37]

as sub-vectors of

v∈ [symbol] ^{NK}. [Math. 38]

The variables

\tilde{w} [Math. 39]

now are referred to as primal variables in ADMM.

Since the optimization problem now admits an ADMM form as in Problem (8), it may be solved via the ADMM algorithm. The augmented Lagrangian with scaled dual variables

ũ^{(k)} [Math. 40]

for Problem (8) is formed as

$$[ Math . 41 ]$$

$${ℒ}_{ρ} ( \overline{w} , v , \overline{u} ) = L ( {\sum }_{k = 1}^{K} {v}^{( k )} - y ) + \frac{λ}{2} {\sum }_{k = 1}^{K} \frac{{‖ {\overline{w}}^{( k )} ‖}_{2}^{2}}{{β}^{( k )}} + \frac{ρ}{2} {\sum }_{k = 1}^{K} {‖ {Φ}^{( k )} {\overline{w}}^{( k )} - {v}^{( k )} + {\overline{u}}^{( k )} ‖}_{2}^{2} - \frac{ρ}{2} {\sum }_{k = 1}^{K} {‖ {\overline{u}}^{( k )} ‖}_{2}^{2} .$$

Then the following ADMM iterations may be performed until a stopping criterion for convergence is satisfied:

$$\begin{matrix}[ Math . 42 ] & \\ {\overline{w}}_{t + 1} := {arg min}_{\overline{w}} {ℒ}_{ρ} ( \overline{w} , {v}_{i} , {\overline{u}}_{t} ) & ( 9 ) \\ {v}_{t + 1} := {arg min}_{v} {ℒ}_{ρ} ( {\overline{w}}_{t + 1} , v , {\overline{u}}_{t} ) & ( 10 ) \\ {\overline{u}}_{t + 1} := {\overline{u}}_{t} + Φ {\overline{w}}_{t + 1} - {v}_{t + 1} & ( 11 )\end{matrix}$$

where the matrix of the entire embedded data is

Φ=[Φ⁽¹⁾Φ⁽²⁾ . . . Φ^{(κ)}]∈ [symbol] ^{N×dκ}. [Math. 43]

It is observed that the

\tilde{w}-update [Math. 44]

step in Equation (9) and the

ũ-update [Math. 45]

step in Equation (11) may be carried out in parallel. In this parallelized case, the ADMM iterations are written as

$$\begin{matrix}[ Math . 48 ] & \\ {\overline{w}}_{t + 1}^{( k )} := {arg min}_{{\overline{w}}^{( k )}} ( \frac{λ {‖ {\overline{w}}^{( k )} ‖}_{2}^{2}}{{β}^{( k )}} + ρ {‖ {Φ}^{( k )} {\overline{w}}^{( k )} - {Φ}^{( k )} {\overline{w}}_{t}^{( k )} + {\overline{Φ \overline{w}}}_{t} - {\overline{v}}_{t} + {u}_{t} ‖}_{2}^{2} ) & ( 15 )\end{matrix}$$

$$\begin{matrix}{\overline{v}}_{t + 1} := {arg min}_{\overline{v}} ( L ( K \overline{v} - y ) + \frac{K ρ}{2} {‖ \overline{v} - {u}_{t} - {\overline{Φ \overline{w}}}_{t + 1} ‖}_{2}^{2} ) & ( 16 ) \\ {u}_{t + 1} := {u}_{t} + {\overline{Φ \overline{w}}}_{t + 1} - {\overline{v}}_{t + 1} & ( 17 )\end{matrix}$$

$$where \\ [ Math . 49 ] \\ {\overline{Φ \overline{w}}}_{t} = ( 1 / K ) {\sum }_{k = 1}^{K} {Φ}^{( k )} {\overline{w}}_{t}^{( k )} .$$

The ADMM iterations may be further simplified by introducing an additional variable

\tilde{v}=(1/K)Σₖ₌₁^{κ}v^{(k)}. [Math. 47]

Then the simplified ADMM iterations are derived as

$$\begin{matrix}[ Math . 46 ] & \\ {\overline{w}}_{t + 1}^{( k )} := {arg min}_{{\overline{w}}^{( k )}} ( \frac{λ {‖ {\overline{w}}^{( k )} ‖}_{2}^{2}}{{β}^{( k )}} + ρ {‖ {Φ}^{( k )} {\overline{w}}^{( k )} - {v}_{t}^{( k )} + {\overline{u}}_{t}^{( k )} ‖}_{2}^{2} ) & ( 12 ) \\ {v}_{t + 1} := {arg min}_{v} {ℒ}_{ρ} ( {\overline{w}}_{t + 1} , v , {\overline{u}}_{t} ) & ( 13 ) \\ {\overline{u}}_{t + 1}^{( k )} := {\overline{u}}_{t}^{( k )} + {Φ}^{( k )} {\overline{w}}_{t + 1}^{( k )} - {v}_{t + 1}^{( k )} & ( 14 )\end{matrix}$$

### The

\tilde{w}-update [Math. 50]

step in Equation (15) essentially involves K independent ridge regression problems that can be solved in parallel. The solution of the

\tilde{v}-update [Math. 51]

step in Equation (16) depends on the loss function

L(·) [Math. 52]

For example, in cases of the square loss, the solution admits a simple closed form; in cases of the hinge loss, the solution may be analytically obtained using the soft-thresholding technique. In the straightforward u-update step, the vectors of dual variables

ũ^{(k)} [Math. 53]

are replaced by a single one u because all of them are equal.

The above ADMM algorithm gives a solution of

\tilde{w}. [Math. 54]

With this

\tilde{w} [Math. 55]

fixed, the solution of (3 can be obtained by solving the following convex problem

$$[ Math . 56 ] \\ {min}_{β} {\sum }_{k = 1}^{K} \frac{{‖ {\overline{w}}^{( k )} ‖}_{2}^{2}}{{β}^{( k )}} \\ s . t . β \geq 0 , {‖ β ‖}_{1} = 1$$

which has a closed form solution

$$\begin{matrix}[ Math . 57 ] & \\ {β}^{( k )} := \frac{{‖ {\overline{w}}^{( k )} ‖}_{2}}{{\sum }_{{k}^{′} = 1}^{K} {‖ {\overline{w}}^{( {k}^{′} )} ‖}_{2}} , for k = 1 , … , K . & ( 18 )\end{matrix}$$

This β-update step may be done either inside or outside the ADMM iterations, termed as “inner update” and “outer update” respectively.

As described above, a combination of the ADMM transforming component 105 and the model training component 106 serves as an optimal solution solving component configured to solve the convex optimization problem to obtain the globally optimal solution for training the interpretable predictive model.

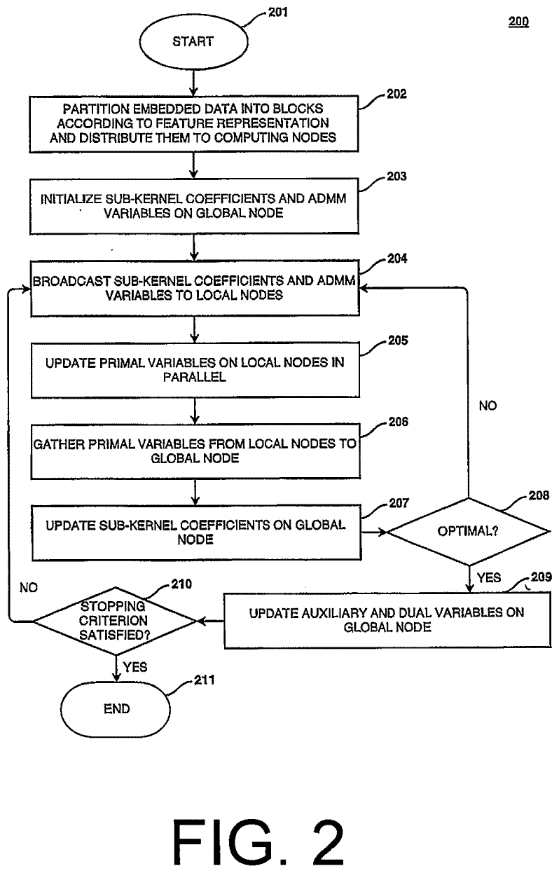

FIG. 2 is a flow diagram that illustrates an operation example of the kernel learning apparatus 100 according to an example embodiment of the present invention. This process shows how to perform an ADMM-based optimization process 200 with inner update in the model training component 106. After the optimization problem is transformed into an ADMM form as in Equation (8), the start step 201 is entered. Then the next step 202 is to partition the embedded data into blocks as

Φ=[Φ⁽¹⁾Φ⁽²⁾ . . . Φ^{(κ)}]∈ [symbol] ^{N×dκ} [Math. 58]

according to feature representations, and distribute them to computing nodes 107. The global node 108 initializes sub-kernel coefficients β and ADMM variables: primal variables

\tilde{w}, [Math. 59]

auxiliary variables

\tilde{v} [Math. 60]

and dual variables

ũ. [Math. 61]

In the broadcast step 204, the global node 108 communicates with local nodes 109 and shares the information of sub-kernel coefficients and ADMM variables. The step 205 is performed in parallel among local nodes, computing the solutions to update primal variables according to Equation (15). In the gather step 206, the global node 108 collects all of updated primal variables and compute the solution of sub-kernel coefficients as in Equation (18). Then the global node 108 checks whether an optimal β is obtained in the step 208 according to a certain criterion: if not, the process goes back to the step 204; otherwise, it proceeds to the step 209 to update auxiliary and dual variables on the global node as in Equation (16) and Equation (17). In the step 210, the global node checks whether a stopping criterion of ADMM is satisfied: if not, the process goes back to the step 204; otherwise, it proceeds to the end step 211 to output the trained model 110 with the final solutions of sub-kernel coefficients and ADMM variables.

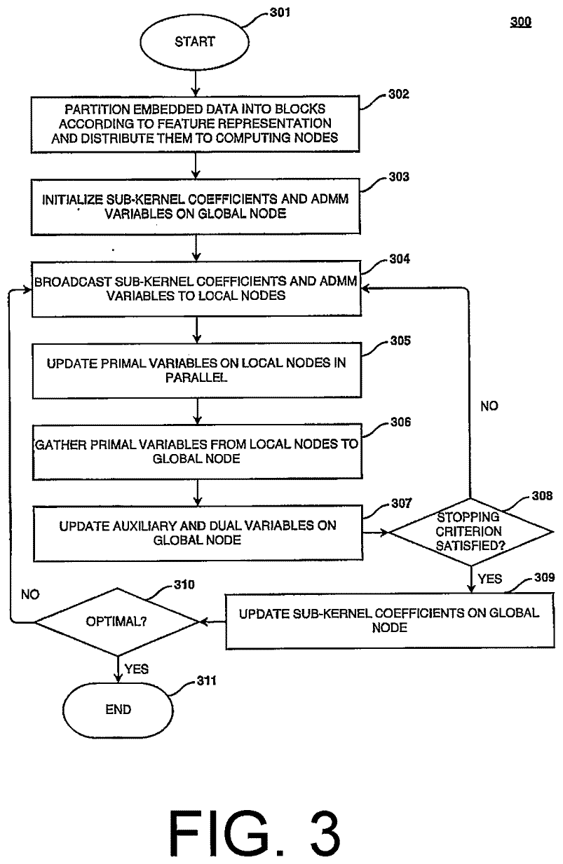

FIG. 3 is a flow diagram that illustrates an operation example of the kernel learning apparatus 100 according to an example embodiment of the present invention. This process 300 is an alternative to the process 200, with outer update instead of inner update. In the process 300, the steps 301, 302, 303, 304, 305 and 306 are first performed similarly as in the process 200. Then in the step 307, the global node 108 updates auxiliary and dual variables according to Equation (16) and Equation (17). In the step 308, the global node 108 checks whether a stopping criterion of ADMM is satisfied: if not, the process goes back to the step 304; otherwise, it goes out of ADMM iterations and proceeds to the step 309 to compute the solution of sub-kernel coefficients on the global node 108 as in Equation (18). Then the global node 108 checks whether an optimal β is obtained in the step 310 according to a certain criterion: if not, the process goes back to the step 304; otherwise, it proceeds to the end step 311 to output the trained model 110 with the final solutions of sub-kernel coefficients and ADMM variables.

The main difference between the process 200 and the process 300 is when the sub-kernel coefficients β are updated. In the process 200, the β-update step is inside ADMM iterations. This requires several times of communication between the global node 108 and local nodes 109 when alternatively updating primal variables

\tilde{w} [Math. 62]

and sub-kernel coefficient β. On the other hand, the β-update step is outside ADMM iterations in the process 300. However, whenever a new but not optimal β is obtained in the step 309, a new epoch of ADMM iterations have to be restarted from the step 304. While in the process 200, there is only one epoch of ADMM iterations.

The respective components of the kernel learning apparatus 100 may be realized using a combination of hardware and software. In a mode where the hardware and the software are combined with each other, the respective components of the kernel learning apparatus 100 are realized as respective various means by developing a kernel learning program in an RAM (random access memory) and by causing the hardware such as a control unit (CPU: central processing unit) and so on to operate based on the kernel learning program. In addition, the kernel learning program may be distributed with it recoded in a recording medium. The kernel learning program recorded in the recording medium is read out to a memory via a wire, a radio, or the recording medium itself to cause the control unit and so on to operate. As the recording medium, an optical disc, a magnetic disk, a semiconductor memory device, a hard disk or the like is exemplified.

If the above-mentioned example embodiment is explained by a different expression, the example embodiment may be realized by causing a computer serving as the kernel learning apparatus 100 to operate, based on the kernel learning program developed in the RAM, as the data preprocessing component 102, the explicit feature mapping component 103, the convex problem formulating component 104, and the optimal solution solving component (the ADMM transforming component 105 and the model training component 106).

### EXAMPLE

Now, description will proceed to an example of the present invention with reference to drawings. In the example being illustrated, the example is an example of prediction task for predicting, as a prediction target y, a house value based on, for example, California Hosing Dataset. It is assumed that the California Hosing Dataset has, as the D features, first through eighth features ×1 to ×8 as described in the following Table 1. That is, in the example being illustrated, D is equal to eight.

TABLE 1

| Name | Description |
|---|---|
| x₁: MedInc | Median income. |
| x₂: HouseAge | Housing median age. |
| x₃: AveRooms | Average number of rooms. |
| x₄: AveBedrms | Average number of bedrooms. |
| x₅: Population | Population in each block group. |
| x₆: AveOccup | Average occupancy in each house. |
| x₇: Latitude | Geographic coordinate (north-south). |
| x₈: Longitude | Geographic coordinate (east-west). |

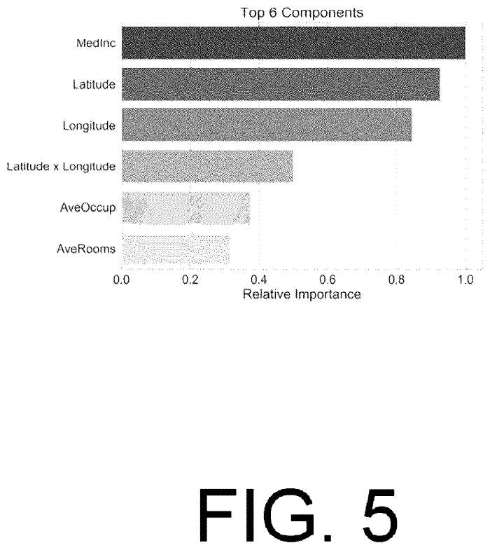

When the California Hosing Dataset is supplied to the trained model 110, the trained model 110 produces the degree of importance for the features in the prediction task, as being illustrated in FIG. 5. As apparent from FIG. 5, it can be confirmed that the features of “MedInc” and “Latitude” are important on predicting the house value.

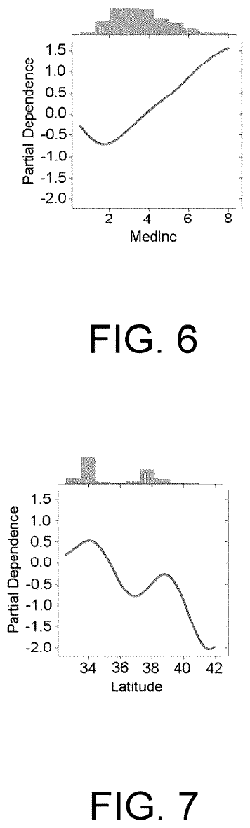

Furthermore, the trained model 110 further produces two drawings as illustrated in FIGS. 6 and 7. In each of FIGS. 6 and 7, the abscissa represents a numeral value of the feature indicative of a single feature and the ordinate represents a partial dependence.

Specifically, FIG. 6 shows a graph where the abscissa represents an amount of the “MedInc” and the ordinate represents the partial dependence of contribution for the house value. As seen from FIG. 6, it can be confirmed that the partial dependence of the house value is improved when the amount of the “MedInc” increases.

FIG. 7 shows a graph where the abscissa represents an amount of the “Latitude” and the ordinate represents the partial dependence for the house value.

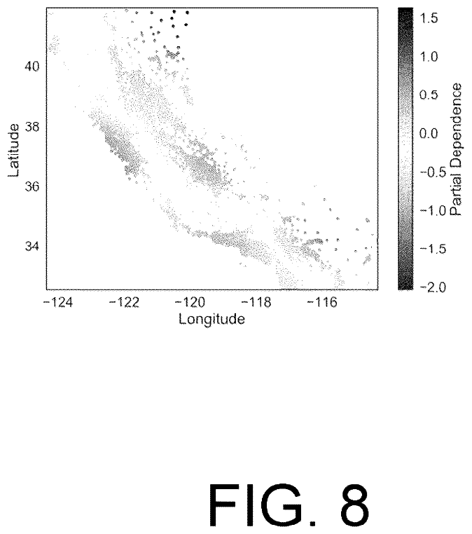

Moreover, the trained model 110 further produces an explanation view indicative of a visualized example of the partial dependence for the features representing an interaction effect as shown in FIG. 8. FIG. 8 shows a graph where the abscissa and the ordinate represent a set of features representing the interaction effect and the partial dependence is denoted at a change of shading in a color. In the example being illustrated, in the graph of FIG. 8, the abscissa represents the feature of “Longitude”, the ordinate represents the feature of “Latitude”, and the shading represents the partial dependence for the house value.

With this configuration, a user can use, as decision making, a predicted selling value and the dependence. For example, the user can determine, based on outputs of the trained model 110, an optimal sales strategy of the house value.

While the invention has been particularly shown and described with reference to an example embodiment thereof, the invention is not limited to the embodiment. It will be understood by those of ordinary skill in the art that various changes in form and details may be made therein without departing from the sprit and scope of the present invention as defined by the claim. For example, the optimal solution solving component may be implemented by any one selected from other solving components although the optimal solution solving component comprises the combination of the ADMM transforming component 105 and the model training component 106 in the above-mentioned example embodiment. More specifically, the ADMM transforming component 105 may be omitted. In this event, the optical solution solving component is implemented by only the model training component except for the ADMM.

### REFERENCE SIGNS LIST

100 Kernel learning apparatus
101 Data examples
102 Data preprocessing component
103 Explicit feature mapping component
104 Convex problem formulating component
105 ADMM transforming component
106 Model training component
107 Computing nodes
108 Global node
109(1), 109(2) Local nodes
110 Trained model

1. A system executed by multiple computer nodes that are capable of communicating with each other, comprising:
a first computer node, which includes:
a data preprocessing circuit configured to preprocess and to represent each data example as a collection of feature representations that to need to be interpreted:
a feature mapping circuit configured to design a kernel function with an explicit feature map to embed the feature representations of the data into a nonlinear feature space and to produce the explicit feature map of the designed kernel function to train a machine learning model;
a convex problem formulating circuit configured to formulate the non-convex problem for training the machine learning model into a convex optimization problem based on the explicit feature map; and
an alternating direction method and multipliers (ADMM) transforming circuit configured to transform the convex optimization problem into an ADMM form where sub-problems can be solved separately and efficiently,
a plurality of second computer nodes, each including:
a model training circuit configured to perform ADMM iterations until convergence in a distributed fashion to train an interpretable machine learning model.

2. The system according to claim 1, wherein the feature mapping circuit is configured to directly approximate the kernel function via random Fourier features (RFFs).

3. The system according to claim 1, wherein the model training circuit is configured to perform the ADMM iterations with inner update.

4. The system according to claim 1, wherein the model training circuit is configured to perform the ADMM iterations with outer update.
